(19) United States
(12) Patent Application Publication
(10) Pub. No.: US 2019/0389737 A1
(43) Pub. Date: Dec. 26, 2019

(54) PROCESS FOR SEQUESTERING SODIUM CHLORIDE AND CALCIUM CHLORIDE FROM A NON-SALEABLE SALT WASTE PRODUCT PRODUCED FROM OIL AND GAS PRODUCED WASTEWATER

(71) Applicant: Clean Water LLC, Charleston, WV (US)

(72) Inventors: DONALD BOOTH, Cross Lanes, WV (US); TONY ANDERSON, Ripley, WV (US)

(21) Appl. No.: 16/419,038

(22) Filed: May 22, 2019

Related U.S. Application Data
(60) Provisional application No. 62/689,181, filed on Jun. 24, 2018.

(51) Int. Cl. C01F 11/32; C01D 3/08; C01D 3/16; B01D 11/02

(52) U.S. Cl. CPC C01F 11/32; C01D 3/08; C01P 2006/80; B01D 11/0288; C01D 3/16

(57) ABSTRACT

A method and system for independently sequestering liquid calcium chloride and pure solid sodium chloride from a solid salt waste mixture including calcium chloride, sodium chloride and impurities. In practice, the method includes a calcium chloride sequestration step, wherein the waste mixture is combined with water, maintaining the calcium chloride within the mixture at least 30% w/w, and the resulting liquid calcium chloride is decanted from such mixture. The remaining salt particulates may be depured by a depuration process, which may include the recycling of salt brine through the depuration process. Particulate impurities in the solid salt waste mixture may also be removed in practice of the methods of the disclosed technology, by means of one or more clarifiers.

### BACKGROUND OF THE TECHNOLOGY

The disclosed technology regards a method and systems for independently sequestering calcium chloride and sodium chloride from solid salt mixtures. The disclosed technology further regards a method and system for treating solid waste mixtures including calcium chloride and sodium chloride resulting from the Zero Liquid Discharge process of desalinating wastewater, such as from oil and gas operations (production and flowback waters), and producing from such waste saleable products including a calcium chloride liquid mixture and high purity solid sodium chloride (within 5% of pure solid sodium chloride).

Industries like the oil and gas industry generate high volumes of wastewater containing calcium chloride, sodium chloride, suspended solids, oil and other impurities. Oil and gas brines typically contain from 20-35% calcium chloride, in some cases reaching 50%. These brines may be disposed of in an injection well, or treated and desalinated into a reusable water stream.

Furthermore, in the water recovery efforts, calcium and other non-sodium cations may be removed from the brine by crystallization using a sodium-based cation chemical. The chemical crystallization and disposal of non-sodium cations ranges from $3.00 to $7.00/bbl, making the process of standard crystallization expensive as compared to the option of disposing the wastewater in an injection well.

Many liquid discharge processes have been developed to separate water from the salts and other elements and impurities in the wastewater, using crystallizers to generate the reusable water stream. However, because these Zero Liquid Discharge processes do not effectively and independently isolate the calcium chloride and the sodium chloride, the processes produce a non-saleable salt waste product, which is disposed of in landfills. In particular, these prior art processes solidify by evaporation the sodium chloride particles with at least some of the calcium chloride, wherein the calcium chloride liquid remaining with the sodium chloride particles solidifies on the outside of the sodium chloride particles due to its higher salinity. The amount of calcium chloride in the salt waste product may vary, depending upon, among other conditions, the operating conditions of the crystallization and evaporation processes and the method of moving the sodium chloride particles through the process stages. Furthermore, this waste product may also include other insoluble salts and particulate impurities based upon the method and effectiveness of the pretreatment processes used.

The disclosed technology sequesters each of the calcium chloride and the sodium chloride from the other solids and insoluble of the non-saleable salt waste product, or similar products, and produces therefrom saleable calcium chloride liquid mixtures (or crystallized calcium chloride) and pure (>94%) solid sodium chloride. Saleable products produced using the disclosed technologies have purity values far exceeding market requirements.

### GENERAL DESCRIPTION

The disclosed technology regards methods and systems for sequestering sodium chloride and calcium chloride from a solid or mostly solid brine mixture of sodium chloride and calcium chloride, presently offered as a disposable waste product of processes treating and desalinating waste waters. Generally, the process includes adding water to the mixed brine solid salt and lightly mixing the solid salt in the water. The amount of water added should maintain the calcium chloride in solution at a level of no less than 30% w/w, or in some embodiments 32-42% w/w; calcium chloride may need to be added to the mix tank to obtain and maintain this concentration, as hereinafter described. Under these conditions, the light mixing (about one-half an hour) releases the calcium chloride from the sodium chloride particles into the liquid. Although process temperatures and pressure may affect the process, ambient temperatures and pressures are suitable for use of the disclosed technology. By this method, calcium chloride liquid as a saleable product and sodium chloride solid are each sequestered, with any other impurities settling on top of the sodium chloride as particulate matter and removed and disposed.

Notably, batches of non-saleable salt waste product resulting from the treatment and desalination processes applied to industrial waste waters will have varying levels of calcium chloride solidified to the sodium chloride. This may depend on the total salt concentration in the original wastewater and injected into the water to remove other impurities, on the Zero Liquid Discharge process used recovering the reusable water, and on the methods employed to move the sodium chloride through the various stages of the water recovery process, as hereinabove discussed. Further, batches of sodium chloride removed from the water recovery process will increase in calcium chloride concentration, as the process continues over time. Thus, calculating the amount of calcium chloride in each batch of the non-saleable salt waste product is helpful to provide an estimate of salt and water (and any additional calcium chloride) in the solution to achieve the intended results, over time, as well as to plan staged salt injection into the mixing tank to increase the effectiveness of the process, as hereinafter discussed.

During the practice of the methods of the disclosed technology, the density and temperature of the liquid may be measured over time to calculate the calcium chloride concentration in the liquid, and maintain the concentration at or above 30% w/w. If the concentration falls near or below 30% w/w, additional salt waste product or calcium chloride may be added to the mixture until the desired concentration is reached. Water may also be added if the concentration of calcium chloride is higher than desired.

Following light mixing (about 20-30 minutes), the mixture settles, and each of the liquid calcium chloride and the solid sodium chloride are independently sequestered, with the solid sodium chloride at the bottom, particulate matter of impurities as a solid layer above the solid sodium chloride, and the concentrated liquid calcium chloride above the impurity layer. Any remaining calcium chloride between the particles of the sodium chloride may then be diluted.

As shown in the enclosed Figures, the methods of the disclosed technology may be conducted in a single stage process (adding all salt at once) or in a staged process (adding salt to the liquid in stages, with the batch having the highest calcium chloride concentration added in the first stage, with water, and the batches having decreasing concentrations of calcium chloride being added in respective subsequent stages, with water, calcium chloride or sodium chloride brine, as necessary to maintain the calcium chloride concentration in solution). Notably, when sodium chloride brine is used in the multi-staged process, the conditions will cause the sodium chloride to precipitate out of the brine solution.

### DRAWINGS

The drawings described herein are for illustrative purposes only of selected embodiments and not all possible or anticipated implementations thereof, and are not intended to limit the scope of the present disclosure.

FIG. 1 is a process flow diagram of an embodiment of the disclosed technology;

FIG. 2 is flowchart of a method of the disclosed technology;

FIG. 3 is a flowchart of another method of the disclosed technology;

FIG. 4 is a flowchart of another method of the disclosed technology;

FIG. 5 is a depiction of an embodiment of a mixing tank useful in the disclosed technology;

FIG. 6 is a block diagram of an embodiment of a system of the disclosed technology.

### DETAILED DESCRIPTION:

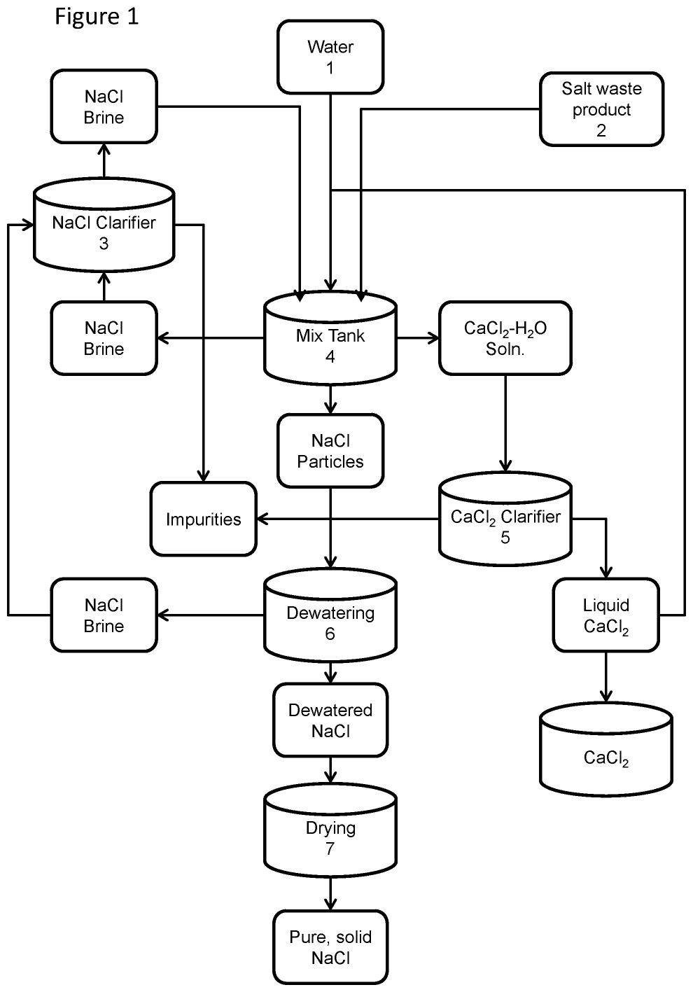

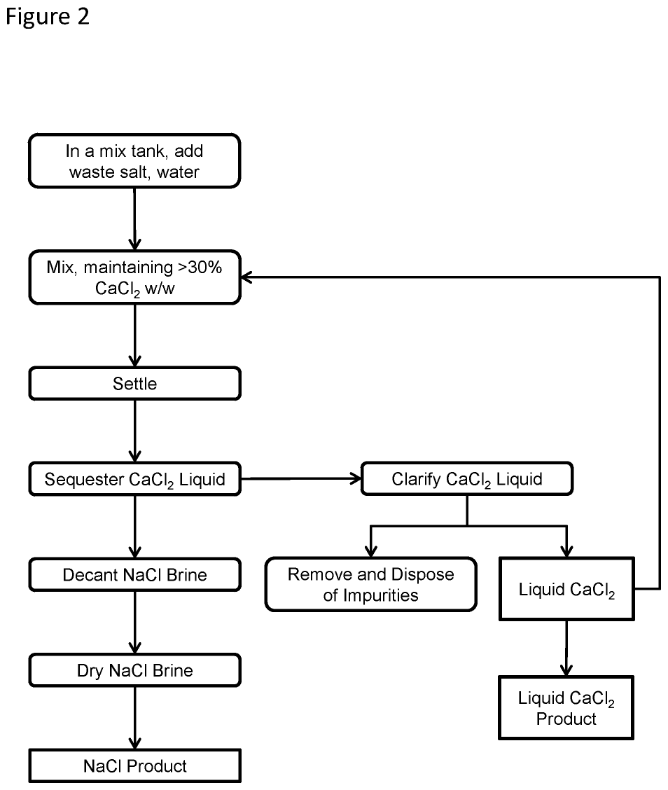

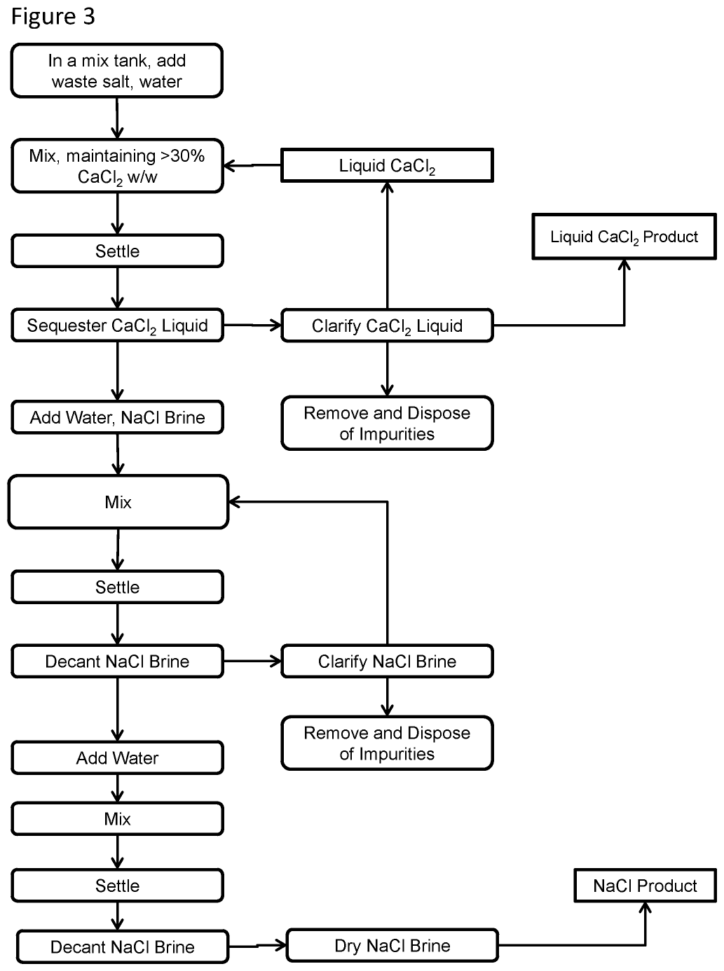

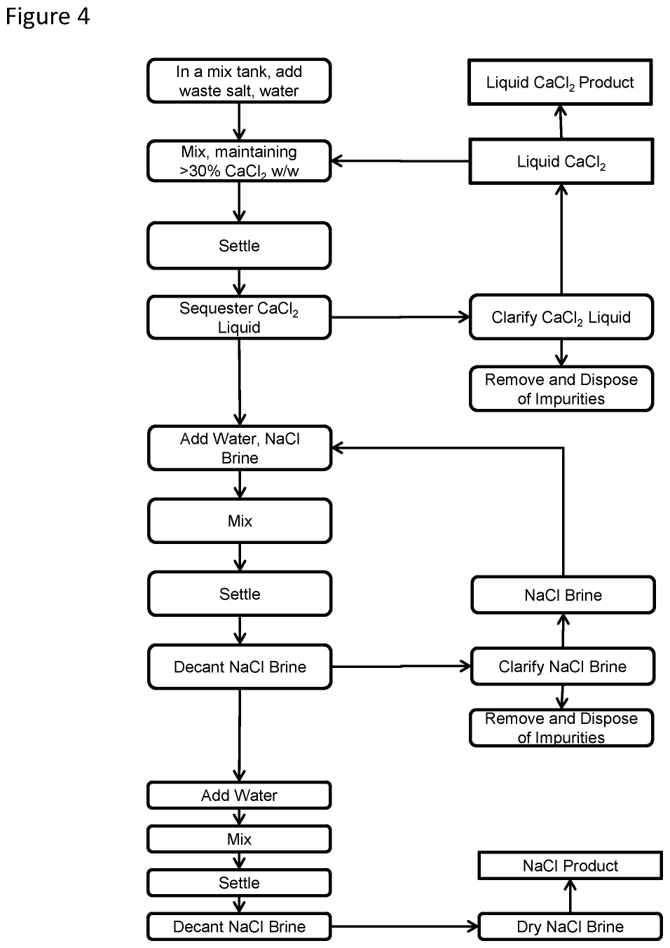

The disclosed technology is a method and system for independently sequestering liquid calcium chloride and solid sodium chloride from a solid salt waste mixture comprising calcium chloride and sodium chloride. The method, depicted through embodiments as shown in FIGS. 1-4, includes a calcium chloride sequestration step (an embodiment of which is shown in FIG. 2), and in some embodiments the calcium chloride sequestration step is coupled with a sodium chloride depuration step (embodiments of which are shown in FIGS. 3 and 4).

In the calcium chloride sequestration step, at least a portion of the solid salt waste mixture, calcium chloride and water are added in a mixing tank to form a heterogeneous mixture. The water and calcium chloride, combined, may have a temperature range of 80-140° F., with specific gravity weight of 81 to 90.5 lbf/ft³ at 1.3 to 1.45 SG.

The heterogeneous mixture is lightly mixed in the mixing tank, releasing the calcium chloride from the sodium chloride particles into the water, and forming a calcium chloride-water solution. During mixing, the calcium chloride is maintained in the mixture at a concentration of no less than 30% w/w; a concentration range of between about 32-42% w/w would be beneficial based upon the available calcium chloride in the mixture. In certain environments where conditions and salts allow for high precision, maintaining the calcium chloride in the heterogeneous mixture at a concentration range of between about 34-36% w/w is possible.

In order to maintain the calcium chloride concentration in the heterogeneous mixture, the method and system of the disclosed technology further calculate the concentration of calcium chloride in the heterogeneous mixture. As background, reference of w/w in this disclosure is the weight of the mixture (calcium chloride, sodium chloride and water), combined to make a liquid gallon. This concentration calculation can be accomplished by many methods, including measuring the density and the temperature of the mixture, and determining the concentration using density/concentration tables, or by inductively coupled plasma (ICP) analysis. For example, if the mixture is measured to have a specific gravity at 70-80° F. of 1.489 Specific Gravity, then the mixture has about 46% concentration of calcium chloride. Should the calcium chloride concentration in the heterogeneous mixture be below the target concentration range, a source of calcium chloride (including, but not limited to, the liquid calcium chloride sequestered by the disclosed technology) can be added to the mixture; suitable sources of calcium chloride include liquid calcium chloride, the solid salt waste mixture, or even the brine with high calcium chloride concentration produced by and recycled through the disclosed technology as hereinafter discussed, which will have some calcium chloride released from the sodium chloride salts during the depuration process. Likewise, if the concentration of calcium chloride in the heterogeneous mixture becomes too high (e.g., above 42%), additional water can be added to the mixture, during the mixing step. Thereby, the calcium chloride can be maintained in the desired concentration range.

After light mixing (e.g., 20-30 minutes), the mixture is allowed to settle, causing the sodium chloride particles to settle out of the mixture at the bottom of the mixing tank and a layer of calcium chloride-water solution above the sodium chloride particles. The calcium chloride-water solution is then decanted from the mixing tank, and the sodium chloride particles are removed from the tank.

Often, the solid salt waste mixture also includes insoluble impurities, such as suspended solids and barium, strontium, or heavy metals. When present, the particulate impurities settle out of the mixture in the mixing tank as a layer between the sodium chloride particles and the calcium chloride-water solution. These particulate impurities may then be decanted from the mixing tank with the calcium chloride-water solution to a calcium chloride clarifier, separating any particulate impurities and insoluble salts from the calcium chloride-water solution. The liquid calcium chloride, so clarified, may then be decanted from the calcium chloride clarifier, and any particulate impurities and insoluble salts may be removed and properly disposed. Suitable calcium chloride clarifiers include settling tanks, with or without baffles, having an agitator such as a pair of rotating blades, and a decanter such as an overflow weir, to decant the clarified calcium chloride from the clarifier, and means such as conveyor belts or scrapers, to remove the insoluble salts and particulate impurities. As hereinabove described, the clarified calcium chloride may be returned to the mixing tank for subsequent sequestration processes.

Although a portion of the calcium chloride sequestered by means of the disclosed technology may be reused in the method and system of the disclosed technology, the remaining clarified calcium chloride is a saleable product in liquid form, or as a crystallized calcium chloride product, for road work or use in high pressure wells, or other useful purposes.

To depure the sodium chloride further, a depuration process may be performed after the calcium chloride-water solution is decanted and before the sodium chloride particulate is removed from the mixing tank, to dilute any remaining calcium chloride which has settled between the sodium chloride particulates. In this process, as shown in FIGS. 3 and 4, additional water is added to the mixing tank to form a second heterogeneous mixture, and the mixture is lightly mixed, releasing additional calcium chloride from the sodium chloride particulates into the mixture. A small portion of the sodium chloride may also dissolve into the mixture. After mixing, this heterogeneous mixture is allowed to settle, causing the remaining sodium chloride particles to settle out of the second mixture at the bottom of the mixing tank, and a layer of brine comprising dissolved sodium chloride, dissolved calcium chloride and water above the sodium chloride particles. The brine is then decanted from the mixing tank. This depuration process may be repeated multiple times, until the desired purity of the sodium chloride particles is achieved. In these repeated cycles, and elsewhere in the process of the disclosed technology, the decanted brine can be added back to the mixing tank with the additional water. The amount of water (and brine, if any) added to the mixing tank should not exceed the amount of water used in the calcium chloride sequestration step.

In the event that the decanted brine has insoluble particles, it may be clarified by decanting it into a sodium chloride clarifier, such as settling tanks, with or without baffles, having an agitator (e.g., a plurality of rotating blades), wherein the brine is allowed to settle, with the insoluble particles settling out of the brine liquid, which can be removed by conveyor belts or scrapers, and disposed. Clarified brine may then be decanted from the sodium chloride clarifier for use as hereinabove described.

The final cycle of the depuration process may include the addition of fresh water, and not brine or calcium chloride, into the mixing tank. After this final cycle, the sodium chloride particles are removed from the mixing tank with final wash water (by pump, conveyor or vacuum, for example), dewatered, further diluting any remaining calcium chloride from the sodium chloride particulates, and dried (by centrifuge, or a drum drier, or other drying method suitable for drying sodium chloride). Any brine removed in the dewatering step may also be reused in the process of the disclosed technology as hereinabove described, and may be clarified with the brine resulting from the depuration process. It has been found that this process can produce calcium chloride impurity levels in the removed sodium chloride particles of less than about 0.9%, and even less than about 0.2% when brine is recycled in the depuration process.

As shown in FIG. 4, in an embodiment of the disclosed technology, a multi-stage calcium chloride sequestration step may be provided, wherein the solid salt waste mixture is added to the mixing tank in batches, and the calcium chloride sequestration step of mixing, settling, and removing the calcium chloride-water solution is repeated for each batch, before any depuration process. During each cycle of mixing, the calcium chloride in solution is maintained at least 30% w/w, or between 32% to 42% w/w, or 34%-36% w/w, as hereinabove described, adding brine, calcium chloride or water as necessary. The batches may be added to the mixing tank in order based upon their calcium chloride content, which may be calculated prior to the calcium chloride sequestration step, by the methods hereinabove described. In practice of the disclosed technology, it has been found that using batches having the highest calcium chloride content in earlier cycles of the calcium chloride sequestration step, and those with lower calcium chloride content in later cycles, is particularly effective in sequestering calcium chloride from the solid salt waste mixture.

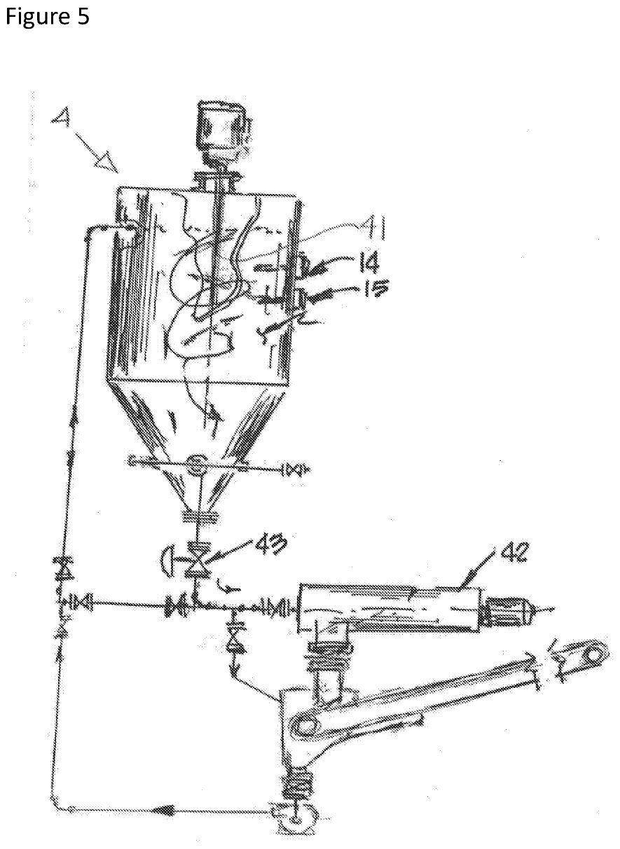

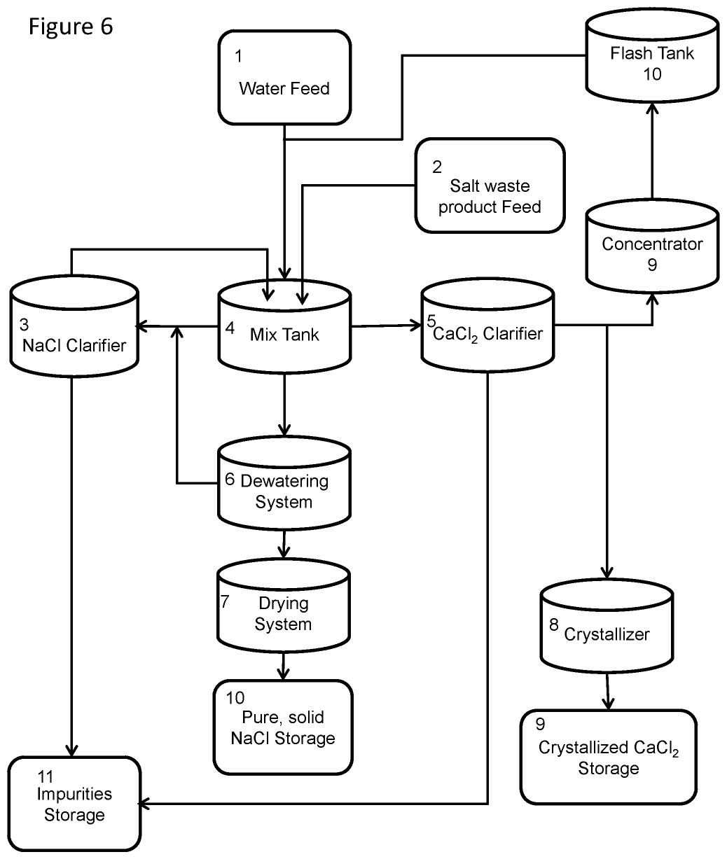

The disclosed technology further provides a system for sequestering calcium chloride and/or sodium chloride from a solid salt waste mixture, such as shown in the embodiments of FIGS. 1 and 6. The system includes a mix tank 4 configured to receive water and the solid salt waste mixture from their respective storage tanks and/or feed systems 1,2, and mix the salt and the water. Sodium chloride brine may further be added to the mix tank 4, from its storage tank 11. As shown in FIG. 5, the mix tank includes an agitator 41, a decanter 42 and a valve 43. The mix tank may be horizontal mixing tank, or a vertical mixing tank; in the embodiment shown in FIG. 5, a cone bottom tank is provided, coated for corrosion resistance and resistance to salt abrasion. The mix tank may further include a temperature sensor 14 and a hydrometer 15, to measure the temperature and density of the mixture over time, and thereby allowing the calcium chloride concentration to be calculated and maintained in the mixture at identified concentration levels or ranges.

The system may further include a calcium chloride clarifier 5, such as hereinabove described. The calcium chloride clarifier, when present, receives the decanted calcium chloride-water solution from the mix tank, with the particulate impurities, and following agitation and settling, separates out any particulate impurities and insoluble salts from the calcium chloride-water solution, allowing liquid calcium chloride, so clarified, to be decanted from the calcium chloride clarifier, and any particulate impurities and insoluble salts may be removed from the clarifier and properly disposed.

When the depuration process is desired in practice of the method of the disclosed technology, the system may include a sodium chloride clarifier 3, as hereinabove described. The sodium chloride clarifier may be in fluid communication with the mix tank, so that it receives the decanted sodium chloride brine from the mix tank, separates out any insoluble particles, and provides clarified brine back to the mix tank for further depuration processes.

The system of the disclosed technology may also include a dewatering belt or centrifuge 6 to dewater sodium chloride particulates and brine removed from the mix tank, after processing, thereby further diluting the calcium chloride from the sodium chloride particulates, and a rotary drier 7 or other means to dry the dewatered sodium chloride particulates. The dewatering belt and rotary drier are coupled with the mix tank 1 to receive the sodium chloride particulates and brine.

Other components of a system of the disclosed technology may include feed tanks, tubes, piping and pumps to provide fluid and delivery communication among the components of the system.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

1. A method for independently sequestering liquid calcium chloride and solid sodium chloride from a solid salt waste mixture comprising calcium chloride and sodium chloride, the method comprising:
in a calcium chloride sequestration step,
adding at least a portion of the solid salt waste mixture and water in a mixing tank to form a heterogeneous mixture;
lightly mixing the heterogeneous mixture to release the calcium chloride from the sodium chloride particles into the water, forming a calcium chloride-water solution, wherein the calcium chloride is maintained in the mixture at a concentration of no less than 30% w/w;
allowing the mixture to settle, causing the sodium chloride particles to settle out of the mixture at the bottom of the mixing tank, with a layer of calcium chloride-water solution above the sodium chloride particles; and
decanting the calcium chloride-water solution from the mixing tank; and
removing the sodium chloride particles from the mixing tank.

2. The method of claim 1, wherein the solid salt waste mixture further comprises particulate impurities; wherein the particulate impurities settle out of the mixture in a layer above the sodium chloride particles; wherein the particulate impurities are decanted from the mixture with the calcium chloride-water solution; and the method further comprising separating and removing the particulate impurities from the decanted calcium chloride-water solution.

3. The method of claim 2, further comprising a depuration step after the calcium chloride-water is decanted and before the sodium chloride is removed from the mixing tank, the depuration step comprising:
adding additional water to the mixing tank to form a second heterogeneous mixture;
lightly mixing the second heterogeneous mixture to release additional calcium chloride from the sodium chloride particles into the water, wherein a small portion of the sodium chloride also dissolves into the water;
allowing the second mixture to settle, causing the remaining sodium chloride particles to settle out of the second mixture at the bottom of the mixing tank and a layer of a brine comprising sodium chloride, calcium chloride and water above the sodium chloride particles; and
decanting the brine from the mixing tank.

4. The method of claim 3, further comprising the step of repeating the depuration step, wherein the decanted brine is added to the mixing tank with the additional water.

5. The method of claim 4, wherein following one or more repetitions of the depuration step, the method further comprising:
adding additional water to the mixing tank to form a third heterogeneous mixture;
lightly mixing the third heterogeneous mixture; and
allowing the second mixture to settle, causing the remaining sodium chloride particles to settle out of the third heterogeneous mixture at the bottom of the mixing tank.

6. The method of claim 5, wherein the calcium chloride impurity level in the sodium chloride particles removed from the mixing tank is less than about 0.2%.

7. The method of claim 5, wherein after the sodium chloride particles are removed from the mixing tank, the sodium chloride salt is dewatered, and the brine resulting from such dewatering process is recycled through the depuration process.

8. The method of claim 3, wherein the calcium chloride impurity level in the sodium chloride particles removed from the mixing tank is less than about 0.9%.

9. The method of claim 1, wherein the calcium chloride is maintained in the heterogeneous mixture at a concentration range of between about 32-42% w/w.

10. The method of claim 9, wherein the calcium chloride is maintained in the concentration range in the solution by adding a water or the calcium chloride water solution to the heterogeneous mixture, while mixing the heterogeneous mixture, when the concentration of calcium chloride falls outside of the concentration range.

11. The method of claim 10, wherein the calcium chloride is maintained in the heterogeneous mixture at a concentration range of between about 34-36% w/w.

12. The method of claim 1, further comprising the step of repeating the calcium chloride sequestration step, wherein an additional solid salt waste batch is added to the mixing tank in each repetition of the calcium chloride sequestration step.

13. The method of claim 13, wherein the concentration of calcium chloride in each of the solid salt waste batches is calculated prior to the calcium chloride sequestration step, and wherein the batch having the highest calcium chloride concentration is added in the first calcium chloride sequestration process, and other solid salt waste batches having decreasing concentrations of calcium chloride are added sequentially in respective subsequent calcium chloride sequestration processes.

14. The method of claim 1, wherein after the sodium chloride salt is removed from the mixing tank, the sodium chloride salt is dewatered and dried.

15. A system for sequestering calcium chloride and/or sodium chloride from a solid salt mixture, the system comprising:
a mix tank which receives and mixes a combination of water, solid salt comprising sodium chloride and calcium chloride, and sequesters solid sodium chloride precipitate from liquid calcium chloride, and further provides sodium chloride brine;
a calcium chloride clarifier in liquid communication with the mix tank to receive the liquid calcium chloride;
a sodium chloride clarifier in liquid communication with the mix tank, to both receive sodium chloride brine from the mix tank, and provide clarified sodium chloride brine back to the mix tank;
a dewatering system in communication with the mix tank to receive the solid sodium chloride, and further in fluid communication with the sodium chloride clarifier to provide any brine resulting from a dewatering process to the sodium chloride clarifier; and
a drying system coupled with the dewatering system to receive and dry the sodium chloride precipitate.

16. A method for treating solid waste mixtures including calcium chloride, sodium chloride and particulate impurities, the waste mixtures resulting from the process of desalinating wastewater, and producing from such waste saleable products including a calcium chloride liquid and a solid sodium chloride, the method comprising the steps of:
in a calcium chloride sequestration step, adding at least a portion of the solid salt waste mixture and water in a mixing tank to form a heterogeneous mixture;
lightly mixing the heterogeneous mixture to release the calcium chloride from the sodium chloride particles into the water, forming a calcium chloride-water solution, wherein the calcium chloride is maintained in the mixture at a concentration of no less than 30% w/w;
allowing the mixture to settle, causing the sodium chloride particles to settle out of the mixture at the bottom of the mixing tank, the particulate impurities settle out of the mixture in a layer above the sodium chloride particles and a layer of calcium chloride-water solution above the sodium chloride particles; and
decanting the calcium chloride-water solution and the particulate impurities from the mixing tank; and
in a depuration step:
adding additional water to the mixing tank to form a second heterogeneous mixture;
lightly mixing the second heterogeneous mixture to release additional calcium chloride from the sodium chloride particles into the water, wherein a small portion of the sodium chloride also dissolve into the water;
allowing the second mixture to settle, causing the remaining sodium chloride particles to settle out of the second mixture at the bottom of the mixing tank and a layer of a brine comprising sodium chloride, calcium chloride and water above the sodium chloride particles; and
decanting the brine from the mixing tank;
following one or more repetitions of the depuration step, adding additional water to the mixing tank to form a third heterogeneous mixture, lightly mixing the third heterogeneous mixture, and allowing the third mixture to settle, causing the remaining sodium chloride particles to settle out of the third mixture;
separating and removing the particulate impurities from the decanted calcium chloride-water solution; and
removing the sodium chloride particles from the mixing tank.

17. The method of claim 16, wherein the calcium chloride is maintained in the heterogeneous mixture at a concentration range of between about 32-42% w/w.

18. The method of claim 16, wherein the calcium chloride is maintained in the heterogeneous mixture at a concentration range of between about 34-36% w/w.

19. The method of claim 16, further comprising the step of repeating the calcium chloride sequestration step, wherein an additional solid salt waste batch is added to the mixing tank in each repetition of the calcium chloride sequestration step, and wherein the concentration of calcium chloride in each of the solid salt waste batches is calculated prior to the calcium chloride sequestration step, and wherein the batch having the highest calcium chloride concentration is added in the first calcium chloride sequestration process, and other solid salt waste batches having decreasing concentrations of calcium chloride are added sequentially in respective subsequent calcium chloride sequestration processes.
